(19) United States
(12) Patent Application Publication
(10) Pub. No.: US 2010/0259761 A1
(43) Pub. Date: Oct. 14, 2010

(54) Robust Long Wire Resistance Thermometer

(75) Inventor: John K. Eaton, Stanford, CA (US)

Correspondence Address: TI Law Group, 2055 Junction Avenue, #205, San Jose, CA, 95131-2116, US

(73) Assignee: Nikon Corporation, Tokyo (JP)

(21) Appl. No.: 12/420,586

(22) Filed: Apr. 8, 2009

(51) Int. Cl. G01B 11/02; H01C 3/00

(52) U.S. Cl. 356/509; 338/28

(57) ABSTRACT

Methods and apparatus for compensating for air or gas temperature fluctuations associated with an interferometer beam path are disclosed. According to one aspect of the present invention, a resistance thermometer assembly includes an insulating tube arrangement, a support arrangement, and a resistance arrangement. The insulating tube arrangement includes a first end and a second end, as well as an insulating tube and a metal film layer that coats the insulating tube. The support arrangement is configured to support the first end and the second end of the insulating tube arrangement. The resistance arrangement is configured to measure a resistance associated with the insulating tube arrangement.

### BACKGROUND OF THE INVENTION

1. Field of the Invention

The present invention relates generally to stage systems. More particularly, the present invention relates to compensating for temperature sensitivities associated with interferometer beams used to measure the position of a stage.

2. Description of the Related Art

The ability to maintain accuracy in precision motion applications is critical. If the accuracy of a precision motion application such as a photolithography application is compromised, for example, the integrity of a wafer processed by the photolithography application may be adversely affected.

Maintaining a relatively uniform temperature with respect to at least some portions of a stage apparatus, e.g., a stage apparatus that is part of an overall photolithography system, is critical to ensure that the stage apparatus operates accurately. For instance, interferometers that effectively measure the position of a stage as the stage translates are sensitive to temperature, and the accuracy with which the interferometers measure position is affected when the temperature varies. As such, to allow an interferometer to operate accurately as calibrated, the temperature of air which flows over an interferometer beam may be maintained at a substantially uniform temperature. However, maintaining a uniform air temperature in the vicinity of an interferometer beam such that there is little impact on the accuracy with which an interferometer operates is often difficult. Even relatively small variations in temperature, e.g., temperature fluctuations on the order of approximately one one-thousandth of a degree Centigrade, may have an adverse impact on the accuracy with which an interferometer operates.

A long wire resistance thermometer made from a fine metal wire has been used to measure the temperature of air in the vicinity of an interferometer beam. However, such a long wire resistance thermometer is generally too delicate to use in a photolithography apparatus, as the slightest amount of contact with the long wire resistance thermometer may cause it to break.

Therefore, what is needed is a method and a system which substantially minimizes the effect of temperature variations in a photolithography apparatus. That is, what is desired is a relatively robust method and a system which reduces the impact of non-uniform air temperatures on the operation of an interferometer included in a stage apparatus.

### SUMMARY OF THE INVENTION

The present invention pertains to estimating an average temperature along an interferometer beam path. The present invention may be implemented in numerous ways, including, but not limited to, as a method, system, device, apparatus, hardware logic, and/or software logic. Example embodiments of the present invention are discussed below.

According to one aspect of the present invention, a resistance thermometer assembly includes an insulating tube arrangement, a support arrangement, and an electrical resistance arrangement. The insulating tube arrangement includes a first end and a second end, as well as an insulating tube and a metal film layer that coats the insulating tube. The support arrangement is configured to support the first end and the second end of the insulating tube arrangement. The electrical resistance arrangement is configured to measure a resistance associated with the insulating tube arrangement. In one embodiment, the insulating tube is a polyimide tube, and the metal film layer is formed from platinum or gold.

According to another aspect of the present invention, a resistance thermometer assembly includes a flexible strip and at least a first metal conductor that is deposited on or otherwise formed on the flexible strip. The resistance thermometer assembly also includes a resistance arrangement. The resistance arrangement is configured to determine a resistance associated with the at least first metal conductor.

In accordance with another aspect of the present invention, the method of compensating for temperature effects in a stage system which includes an interferometer and a stage involves estimating a temperature of air. The air flows over a beam provided by the interferometer, and estimating the temperature of the air includes positioning the resistance thermometer in the air parallel to the length of the beam. The resistance thermometer includes a polyimide structure and a metal structure. The method also includes processing the temperature of the air. Processing the temperature of the air includes determining whether the interferometer is to be adjusted to compensate for the temperature of the air. The interferometer is adjusted if it is determined that the interferometer is to be adjusted to compensate for the temperature of the air.

Other aspects of the invention will become apparent from the following detailed description taken in conjunction with the accompanying drawings which illustrate, by way of example, the principles of the invention.

### BRIEF DESCRIPTION OF THE DRAWINGS

The invention will be readily understood by the following detailed description in conjunction with the accompanying drawings, in which:

FIG. 1 is a diagrammatic representation of an overall stage system which includes a long wire resistance thermometer that is suitable for measuring temperatures along the length of an interferometer beam in accordance with an embodiment of the present invention.

FIG. 2 is a diagrammatic representation of a process of using temperature information to adjust an interferometer beam associated with an overall stage system in accordance with an embodiment of the present invention.

FIG. 3A is a diagrammatic representation of a long wire resistance thermometer assembly that includes tubing in accordance with an embodiment of the present invention.

FIG. 3B is a diagrammatic perspective representation of a portion of a long wire resistance thermometer assembly, e.g., portion 332 of assembly 316 of FIG. 3A, in accordance with an embodiment of the present invention.

FIG. 4 is a process flow diagram which illustrates a method of forming a long wire resistance thermometer assembly in accordance with an embodiment of the present invention.

FIG. 5A is a diagrammatic representation of a long wire resistance thermometer assembly that includes a relatively narrow strip of film on which a long wire sensor, or a resistance temperature detector, is mounted in accordance with an embodiment of the present invention.

FIG. 5B is a diagrammatic representation of a long wire resistance thermometer assembly that includes a relatively narrow strip of film on which a plurality of long wire sensors are mounted in accordance with an embodiment of the present invention.

FIG. 6A is a diagrammatic representation of a long wire resistance thermometer assembly that includes a relatively narrow strip of film on which multiple long wire sensors of different lengths are mounted in accordance with an embodiment of the present invention.

FIG. 6B is a diagrammatic representation of an overall stage system which includes a long wire resistance thermometer assembly, e.g., long wire resistance thermometer assembly 616 if FIG. 6A, and a stage positioned at a first position in accordance with an embodiment of the present invention.

FIG. 6C is a diagrammatic representation of an overall stage system which includes a long wire resistance thermometer assembly, e.g., long wire resistance thermometer assembly 616 if FIG. 6A, and a stage positioned at a second position in accordance with an embodiment of the present invention.

FIG. 7 is a diagrammatic representation of a long wire resistance thermometer assembly that includes a relatively narrow strip of film on which a zig-zagged long wire sensor is mounted in accordance with an embodiment of the present invention.

FIG. 8 is a process flow diagram which illustrates a method of accounting for temperature changes in air that flows substantially over an interferometer beam from the point-of-view of a control arrangement in accordance with an embodiment of the present invention.

FIG. 9 is a diagrammatic representation of a photolithography apparatus in accordance with an embodiment of the present invention.

FIG. 10 is a process flow diagram which illustrates the steps associated with fabricating a semiconductor device in accordance with an embodiment of the present invention.

FIG. 11 is a process flow diagram which illustrates the steps associated with processing a wafer, i.e., step 1004 of FIG. 10, in accordance with an embodiment of the present invention.

### DETAILED DESCRIPTION OF THE INVENTION

Example embodiments of the present invention are discussed below with reference to the various figures. However, those skilled in the art will readily appreciate that the detailed description given herein with respect to these figures is for explanatory purposes, as the invention extends beyond these embodiments.

Maintaining a uniform temperature over an interferometer beam used to measure a position of a stage used in a photolithography apparatus is crucial to ensure that the interferometer beam may accurately measure the position of the stage. Maintaining a uniform temperature in air that flows over an interferometer beam, however, is difficult.

Adjusting characteristics associated with an interferometer measurement system in response to changes in the temperature of air moving over the interferometer beam effectively allows the interferometer system to more accurately measure the position of a stage. When it is determined that the temperature of moving air has increased or decreased, appropriate measures may be taken to calibrate a controller or control system to process the interferometer signal in a manner that accounts for the increase or decrease in the temperature of moving air.

As will be appreciated by those skilled in the art, a laser interferometer may be arranged to measure a beam path length in terms of the wavelength of laser light. Fluctuations in air temperature along a beam path may cause noise which affects the performance of the interferometer. A long wire resistance thermometer is arranged to provide a control system, e.g., a stage control system, with information about the air temperature along a beam path that effectively compensates for measurements made by the interferometer when the beam path fluctuates.

A long wire resistance thermometer which is positioned substantially parallel to an interferometer beam in moving air allows an average temperature of the moving air to be estimated. A long wire resistance thermometer is such that an electrical resistance of a wire changes as the temperature to which the wire is subjected changes. In one embodiment, a long wire resistance thermometer is formed from a relatively thick-walled electrically insulating tube that is coated with a metal film. A long wire resistance thermometer that may be formed from a metal-coated insulating tube, e.g., a tube formed from polyimide and coated with a metal such as gold or platinum. In another embodiment, a long wire resistance thermometer is formed from a film on which at least one metal conductor is deposited or otherwise mounted.

Long wire resistance thermometers which are formed from relatively thick-walled insulating tubes, and long wire resistance thermometers which are formed from metal conductors deposited on a film are relatively robust as they are generally capable of withstanding a larger force than resistance thermometers with comparable characteristics that are formed from relatively thin wires. For example, a thin wire that is approximately ten micrometers (μm) in diameter is generally not able to bear as much force as an insulating polymer tube that is approximately 0.34 millimeters (mm) in diameter on which a metal coating of approximately 0.16 μm is formed. It should be appreciated that the thin wire and the metal-coated insulating polymer tube may have approximately the same resistance. In one embodiment, the resistance of the metal-coated insulating polymer tube may be selected such that substantially the same sensitivity as an approximately ten μm diameter wire is achieved. Hence, the product of the wire resistance multiplied by the associated temperature coefficient of resistance may be chosen to be substantially the same for the wire and the metal coating or film on the insulating polymer tube. Further, a platinum conductor that is approximately 0.5 mm wide and approximately 0.3 μm thick that is deposited on a strip of film, e.g., Kapton film, may have substantially the same resistance and sensitivity as a tungsten wire that has a diameter of approximately ten μm, but may be able to bear more force.

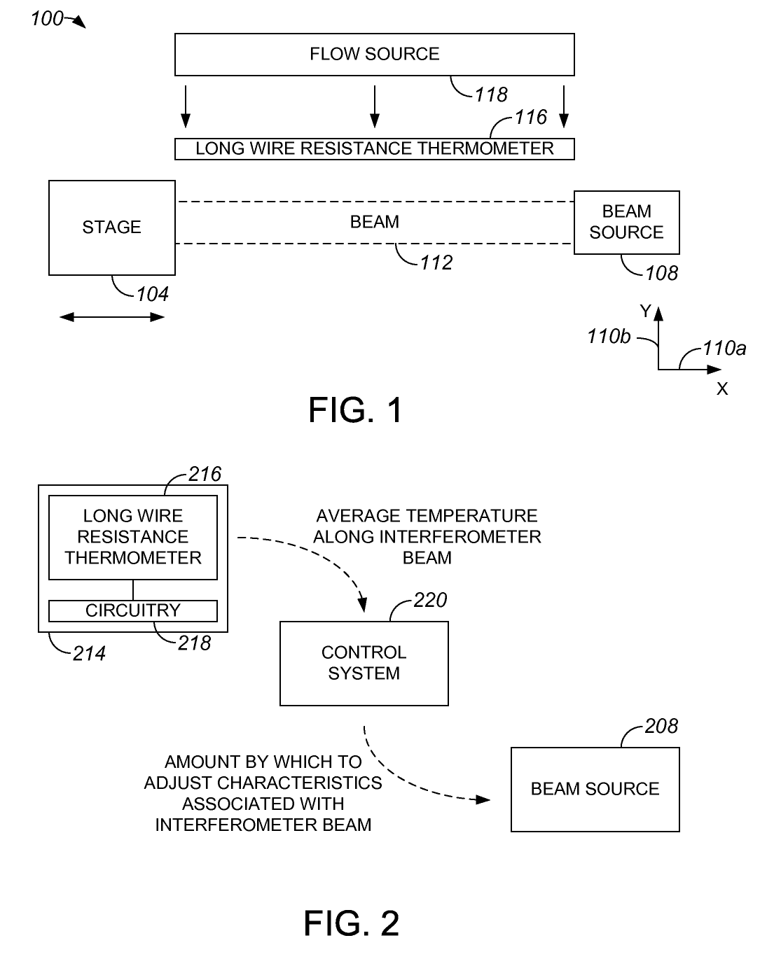

Referring initially to FIG. 1, an overall stage system which includes a long wire resistance thermometer that is suitable for measuring temperatures along the length of an interferometer beam will be described in accordance with an embodiment of the present invention. An overall stage system 100, which may be a part of a photolithography apparatus, includes a stage 104 that is arranged to translate at least in an x-direction 110a. Stage 104 may be substantially any stage that is used in a photolithography apparatus. For example, stage 104 may be a reticle stage, a wafer stage, or a wafer table.

A beam source 108 is arranged to effectively generate a beam 112 that may be used to detect a position of stage 104. In one embodiment, beam source 108 is an interferometer and beam 112 is an interferometer beam. Beam 112 may be a beam of laser light, although beam 112 is not limited to being substantially visible light.

A long wire resistance thermometer 116 is positioned substantially parallel to beam 112. Long wire resistance thermometer 116, which may be formed from a relatively thick-walled polyimide tube that is coated with a relatively thin metal film, is arranged substantially downstream from a flow source 118 that blows air over beam 112, e.g., in a y-direction 110b. Flow source 118 may include an air duct or duct jet which expels air such that the air flows over beam 112. An approximately average temperature of the air which blows over beam 112 may be estimated by long wire resistance thermometer 116. Using information regarding the approximately average temperature of the air, a control system (not shown) may effectively alter the interferometer calibration as appropriate to account for the temperature of the air. That is, as beam 112 is sensitive to temperature, using temperature information provided by long wire resistance thermometer 116, a control system (not shown) may substantially compensate for the temperature of the air such that the position of stage 104 may be accurately measured.

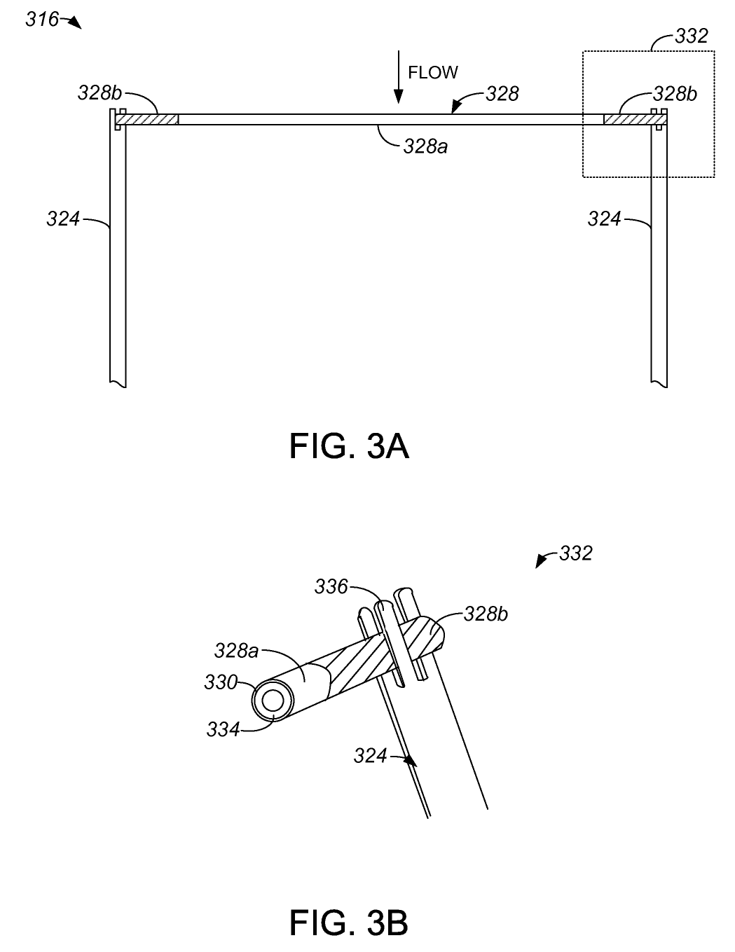

FIG. 2 is a diagrammatic representation of a process of using temperature information to adjust an interferometer beam, or to otherwise calibrate an interferometer that produces the interferometer beam, associated with an overall stage system in accordance with an embodiment of the present invention. A long wire resistance thermometer arrangement 214 includes a long wire resistance thermometer 216 that effectively collects temperature information relating to air that flows over an interferometer beam (not shown). Arrangement 214 is arranged to estimate an average temperature along an interferometer beam (not shown). In one embodiment, circuitry 218 includes a bridge circuit that enables a resistance associated with long wire resistance thermometer 216 to be determined. Using the resistance, arrangement 214 may estimate a temperature, e.g., an average temperature along an interferometer beam (not shown).

Assembly 214 provides the average temperature along an interferometer beam (not shown) associated with a beam source 208 to a control system 220. Control system 220 is configured to determine adjustments to make that substantially account for the average temperature. In other words, control system 220 may determine adjustments to be made, if any, to an interferometer calibration based on the average temperature. Information regarding the adjustments to be made are used by control system 220 to perform an interferometer calibration that accounts for the average temperature such that, in one embodiment, the accuracy with which a stage position may be measured is improved beam source 208, in one embodiment, such that beam source 208 may be adjusted as appropriate.

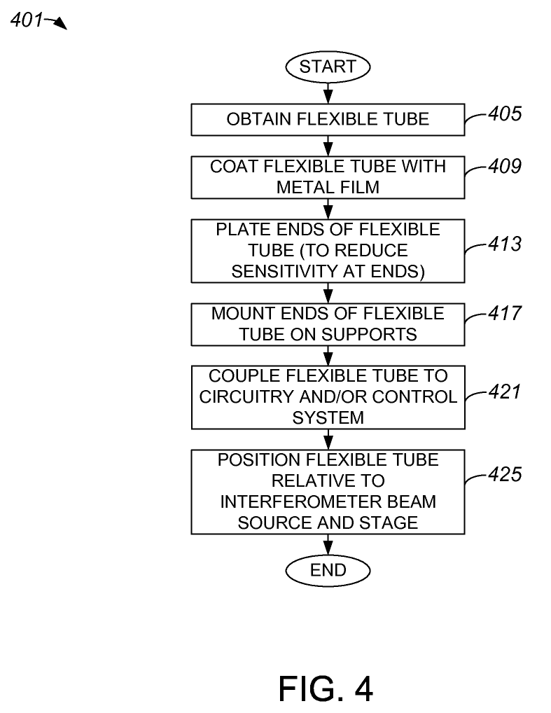

With reference to FIGS. 3A and 3B, a long wire resistance thermometer assembly that includes a metal-coated tube will be described in accordance with an embodiment of the present invention. As shown in FIG. 3A, a long wire resistance thermometer assembly 316 includes a metal-coated tube 328 which effectively serves as a temperature probe, and is secured by supports 324. Supports 324 are arranged to support metal-coated tube 328 such that metal-coated tube 328 is positioned substantially perpendicular to a direction in which air flows.

Typically, metal-coated tube 328 includes an active region 328a and inactive regions 328b. Active region 328a is sensitive, while inactive regions 328b are generally not sensitive. In other words, there is a higher change in resistance relating to a temperature change in active region 328a than in inactive regions 328b. Hence, active region 328a is generally arranged to determine an air temperature while low, substantially constant-resistance inactive regions 328b are generally not arranged to determine an air temperature. When metal-coated tube 328 is approximately 10 centimeters (cm) to approximately 20 cm in length, inactive regions 328b may each occupy approximately 2 cm of the ends of metal-coated tube 328.

Metal-coated tube 328 is typically supported by supports 324 at inactive regions 328b. Supports 324 may be formed from any suitable material including, but not limited to including, steel. In one embodiment, inactive regions 328b may be supported by crimped ends of supports 324. FIG. 3B is a perspective representation of an area 332 of assembly 316 that includes an inactive region 328b and a crimped end 336 of a support 324. An inactive region 328b may be mechanically mounted on crimped end 336, or may be soldered, e.g., soft-soldered, to crimped end 336. Inactive region 328b may also be bonded to crimped end 336 using electrically conductive adhesive, such as silver-filled epoxy or another adhesive with a relatively high electrical conductivity.

Metal-coated tube 328 may be formed from a relatively thick-walled tube 334 made of a material such as polyimide. Types of polyimide which are suitable for use in thick-walled tube 334 include, but are not limited to including, Kapton. The diameter of thick-walled tube 334 may vary widely depending on factors such as the maximum air velocity that assembly 316 is expected to be subjected to, and the length of metal-coated tube 328. By way of example, for a maximum expected air velocity of approximately 0.5 meters per second (m/s), and a length of between approximately 10 cm and approximately 20 cm, thick-walled tube 334 may have an outside diameter of approximately 0.34 mm and an inner diameter of approximately 0.226 mm.

Metal coating 330, or a relatively thin film of metal, may be formed on thick-walled tube 334. Metal coating 330 is arranged to allow metal-coated tube 328 to effectively maintain approximately the same resistance as found in tungsten wire. That is, metal coating 330 may be formed from metal which has a similar thermal coefficient of resistance as that of tungsten when measured at the same temperature. The thermal or temperature coefficient of resistance of tungsten at approximately 20 degrees Celsius may be approximately 0.0048 per degree Celsius. When metal coating 330 is a film of platinum, the thickness of metal coating 330 may be approximately 0.16 μm, and when metal coating 330 is a film of gold, the thickness of metal coating 330 may be approximately 0.034 μm. It should be appreciated, however, that the thickness of metal coating 330 may generally vary.

Inactive regions 328b are plated with metal, e.g., gold. In general, inactive regions 328b are plated with metal which overlies metal coating 330. The thickness of the plating on inactive regions 328b is generally thicker than the thickness of metal coating 330 to reduce the sensitivity of inactive regions 328b, and to facilitate the mounting of inactive regions 328b on supports 324. The plating may be between approximately 2 and approximately 5 μm thick, although one skilled in the art will recognize that substantially any plating thickness that renders the resistance of the inactive region to be significantly less than the resistance of the active region may be used.

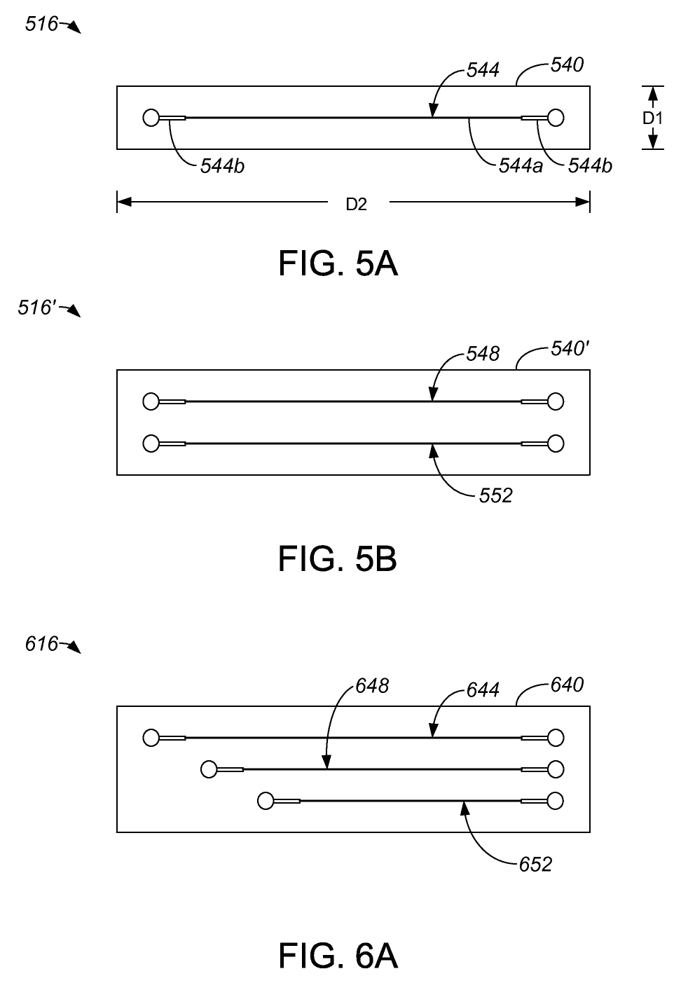

FIG. 4 is a process flow diagram which illustrates a method of forming a long wire resistance thermometer assembly in accordance with an embodiment of the present invention. A process 401 of forming a long wire resistance thermometer assembly begins at step 405 in which an insulating tube, e.g., a polyimide tube, is obtained. In one embodiment, the insulating tube is a hollow tube, although it should be appreciated that the insulating tube may instead be a substantially solid tube. An insulating tube may have a length of between approximately 10 cm and approximately 20 cm, and may have an outer diameter of between approximately 0.24 mm and approximately 0.34 mm, although it should be appreciated that the length and the outer diameter of the insulating tube may vary widely.

The insulating tube is coated with a metal film in step 409. The metal film may be formed from gold or platinum, or any other metal which has relatively stable thermal, electrical, and mechanical properties and is non-corroding. After the insulating tube is coated with a metal film, the ends of the insulating tube are plated in step 413 to reduce sensitivity at the ends. Once the ends of the insulating tube are plated, the ends of the insulating tube are mounted on supports in step 417. The supports may include crimped areas or prongs which are arranged to hold the ends of the insulating tube, as previously described with respect to FIG. 3B.

In step 421, the metal-coated insulating tube is coupled to circuitry and/or a control system that effectively allow the metal-coated insulating tube to function as a temperature probe or sensor. That is, the metal-coated insulating tube is coupled to circuitry and/or a control system such that a resistance thermometer is formed. The circuitry may include a bridge circuit that allows the resistance in the metal-coated insulating tube to be sensed, as will be understood by those skilled in the art. The circuitry may also include circuitry that accounts for the dynamic response associated with the metal-coated insulating tube using a lumped capacitance model. As will be understood by those skilled in the art, the dynamic response is associated with an amount of time needed for thermal diffusion through the wall of the insulating tube to occur.

From step 421, process flow moves to step 425 in which the metal-coated insulating tube is positioned in a stage apparatus relative to an interferometer beam. The metal-coated insulating tube is generally positioned parallel to the interferometer beam. In addition, the metal-coated insulating tube may be aligned downstream from a flow source such that the metal-coated insulating tube may be used to measure a temperature associated with a flow provided by the flow source. The metal-coated insulating tube may be positioned such that the ends of the metal-coated insulating tube, e.g., the inactive regions of the metal-coated insulating tube, are positioned outside of a flow area, while the active regions of the metal-coated insulating tube are positioned in the flow area. After the metal-coated insulating tube is positioned relative to the interferometer beam, the process of forming a long wire resistance thermometer is completed.

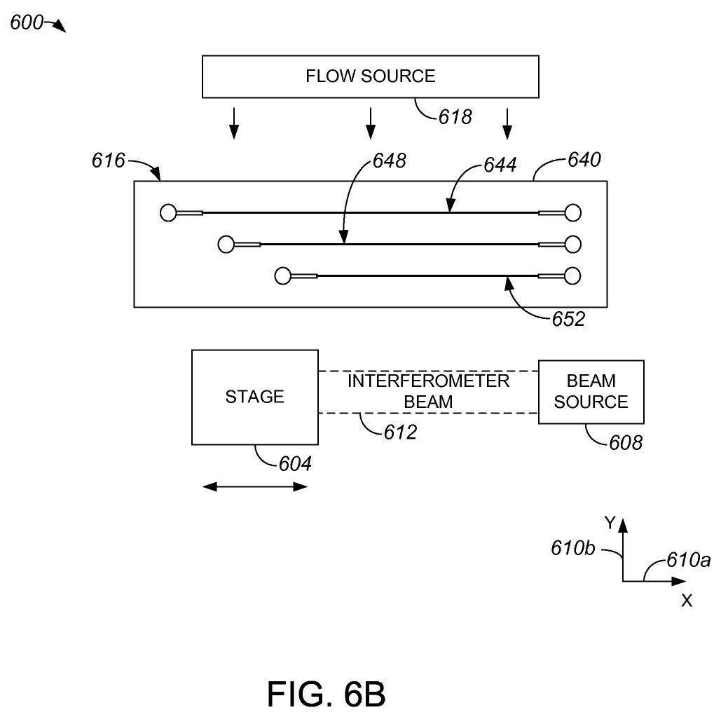

While a long wire resistance thermometer which utilizes a relatively thick-walled tube coated with a thin metal film is robust in that it may bear more force than a long wire resistance thermometer formed from a thin wire, other long wire resistance thermometers may also be relatively robust. For example, a long wire resistance thermometer which is formed from at least one thin metal conductor deposited on a strip of film may be relatively robust. Referring next to FIG. 5A, a long wire resistance thermometer assembly that includes a relatively narrow strip of film on which a long wire sensor, or a resistance temperature detector, is mounted will be described in accordance with an embodiment of the present invention. A long wire resistance thermometer assembly 516 includes a metal conductor or trace 544. Metal conductor 544 may include an active region 544a and inactive regions 554b. Inactive regions 554b may be arranged to be mounted to supports (not shown), although thermometer assembly 516 may instead be mounted on supports at edges of assembly 516 when assembly 516 is stretched between the supports. While the dimensions of metal conductor 544 may vary, metal conductor 544 may be sized to provide approximately the same resistance and sensitivity as a Tungsten wire which has an approximately 10 μm diameter. By way of example, when metal conductor 544 is formed from platinum, metal conductor 544 may be approximately 0.5 mm wide and approximately 0.3 μm thick.

Metal conductor 544 is deposited or otherwise applied to a strip of thin film 540. Thin film 540 may be formed from, but is not limited to being formed from, polyimide, e.g., Kapton. Thin film 540 is typically sized to span the width of an air flow jet for which an average temperature is to be estimated. In one embodiment, thin film 540 may be approximately 0.1 mm thick, have a width D1 that is approximately 0.25 mm, and have a length D2 that is approximately the width of an air flow jet for which an average temperature is to be estimated.

A long wire resistance thermometer that is formed from a strip of thin film may have more than one metal conductor deposited thereon. When more than one metal conductor is deposited on a strip of thin film, substantially simultaneous temperature and velocity measurements may be made with reference to each of the metal conductors. Hence, an average temperature associated with the flow of air may be estimated from the substantially simultaneous measurements using temporal correlation methods. Such temporal correlation methods may utilize information such as a distance between metal conductors, changes in resistance at each metal conductor to estimate an average temperature of the air flow, and velocity at which the air flows.

FIG. 5B is a diagrammatic representation of a long wire resistance thermometer assembly that includes a relatively narrow strip of film on which a plurality of metal conductors are mounted in accordance with an embodiment of the present invention. A long wire resistance thermometer assembly 516′ includes a first metal conductor 548 and a second metal conductor 552 that are deposited or otherwise mounted on a strip of thin film 540′. First metal conductor 548 and second metal conductor 552 are substantially parallel to each other and are separated by a distance. When assembly 516′ is positioned in the path of an airjet, a temperature fluctuation in the air jet or flow is arranged to contact first metal conductor 548 prior to contacting second metal conductor 552. A control system such as control system 220 of FIG. 2 may use temperature measurements from first metal conductor 548 and second metal conductor 552 to determine when the temperature fluctuation will likely arrive at the interferometer beam path.

To enhance the accuracy with which an average temperature of air flowing over an interferometer beam may be estimated, multiple metal conductors mounted on a strip of thin film may be sized such that different metal conductors may be used to estimate an average temperature depending upon the distance traversed by an interferometer beam. That is, the selection of which metal conductor of a plurality of segmented conductors to use in the estimation of an average air temperature may depend upon position of a stage whose position is determined using an interferometer beam. The metal conductors may be multiplexed, as will be appreciated by those skilled in the art. Each metal conductor mounted on a strip of thin film may have a different length, and the metal conductor used to estimate an average air temperature may be the metal conductor with a length that is closest to a current distance traversed by the interferometer beam.

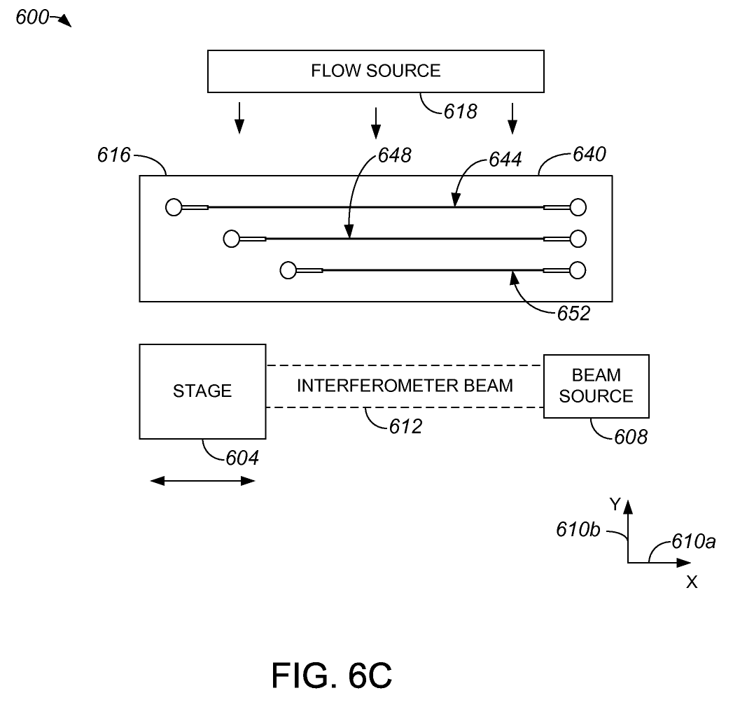

With reference to FIG. 6A, a long wire resistance thermometer assembly that includes a relatively narrow strip of film on which multiple long wire sensors, e.g., metal conductors, of different lengths are mounted will be described in accordance with an embodiment of the present invention. A long wire resistance thermometer assembly 616 includes multiple metal conductors 644, 648, 652 deposited on or otherwise mounted on a strip of thin film 640. Metal conductors 644, 648, 652 are of different lengths. As shown, metal conductor 644 has a relatively long path length while metal conductor 652 has a relatively short path length.

Assembly 616 may be placed in a flow of air such that an average temperature of the air may be estimated. When placed in a flow of air, active regions of metal conductors 644, 648, 652 are typically positioned in the flow while inactive regions of metal conductors 644, 648, 652 are positioned substantially outside of the flow. When assembly 616 is used to estimate an average temperature of air that flows over an interferometer beam, the metal conductor 644, 648, 652 which has a length that is closest to a length of the interferometer beam may be selected for use in estimating the average temperature. FIG. 6B is a diagrammatic representation of an overall stage system which includes long wire resistance thermometer assembly 616 and a stage positioned at a first position in accordance with an embodiment of the present invention. An overall stage system 600 includes a stage 604 that translates in an x-direction 610a. A beam source 608, e.g., an interferometer arrangement, produces an interferometer beam 612 that is used to determine a position of stage 604 as stage 604 translates.

A flow source 618, which produces a jet of air that is arranged to flow over interferometer beam 612, generally along a y-direction 610b. Assembly 616 is positioned between flow source 618 and interferometer beam 612 such that lengths of metal conductors 644, 648, 652 are aligned substantially parallel to interferometer beam 612, or such that metal conductors 644, 648, 652 are separated in a substantially streamwise direction. As shown, when stage 604 is located in a position such that interferometer beam 612 has approximately the same length as an active region of metal conductor 652, metal conductor 652 is used within assembly 616 to estimate an average temperature of the air flowing over interferometer beam 612.

FIG. 6C represents stage system 600 when stage 604 is at a second position in accordance with an embodiment of the present invention. As stage 604 scans along x-direction 610a, the length of interferometer beam 612 may change. Hence, the length of interferometer beam 612 may vary between being approximately the same length as metal conductor 652, metal conductor 648, and metal conductor 644. When the length of interferometer beam 612 is approximately the same as the length of an active region of metal conductor 648, metal conductor 648 is used by assembly 616 to estimate an average temperature of the air flowing over interferometer beam 612.

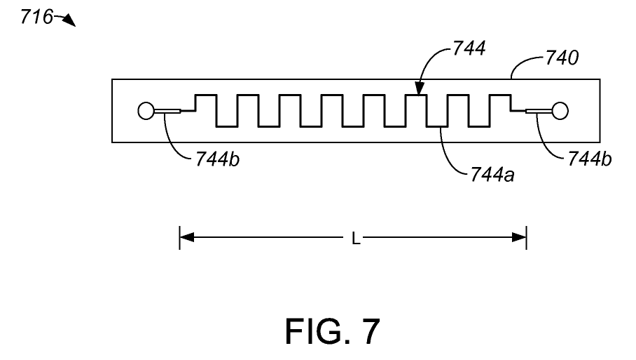

Long wire resistance thermometer assemblies that include relatively narrow strips of thin film, e.g., flexible thin film, on which metal conductors are deposited have been described as being relatively linear such that a path length of the active region of each metal conductor is approximately the same as an overall distance between inactive regions of each metal conductor. However, a metal conductor deposited on a strip of thin film is not limited to being deposited substantially linearly, e.g., as a straight line. A metal conductor or sensor may take on a variety of different geometries. Some geometries may be selected such that the sensitivity of the metal conductor is substantially increased. In general, the longer the length of a metal conductor, the more resistance the metal conductor may provide. As sensitivity to temperature is a function of resistance, increasing the path length of a metal conductor increases the accuracy with which the metal conductor may be used to measure temperature. In one embodiment, a long wire resistance thermometer assembly may include a metal conductor which has a substantially zig-zagged shape. FIG. 7 is a diagrammatic representation of a long wire resistance thermometer assembly that includes a relatively narrow strip of film on which a zig-zagged long wire sensor is mounted in accordance with an embodiment of the present invention. A long wire resistance thermometer 716 includes a strip of thin film 740 on which a metal conductor or sensor 744 is deposited. Metal conductor 744 includes an active region 744a and inactive regions 744b. Active region 744a has a zig-zagged shape such that the path length of active region 744a is greater than a length L as measured between ends of active region 744a. The zig-zagged shape of active region 744a allows active region 744a to be more sensitive to temperature changes than an active region of with a path length substantially equal to length L.

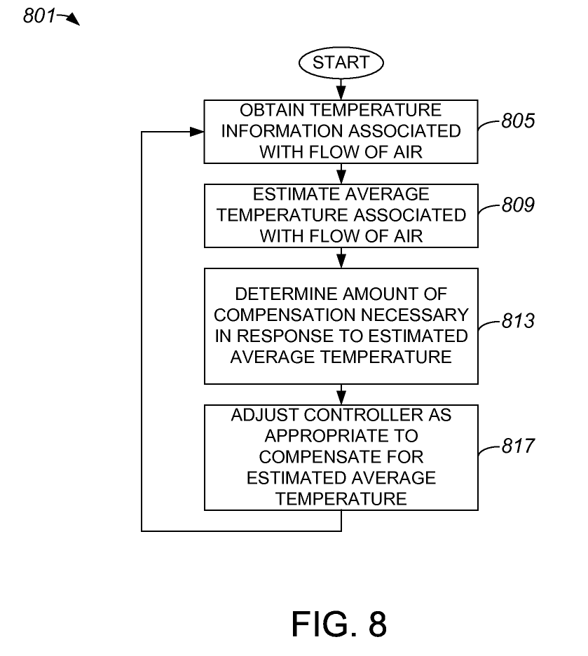

FIG. 8 is a process flow diagram which illustrates a method of accounting for temperature changes in air that flows substantially over an interferometer beam from the point-of-view of a control arrangement in accordance with an embodiment of the present invention. A process 801 of accounting for temperature changes begins at step 805 in which temperature information associated with an air flow is obtained. In one embodiment, the temperature information is obtained from a long wire resistance thermometer. The temperature information may be provided as a resistance measurement associated with the long wire resistance thermometer.

Upon obtaining the temperature information, the control arrangement estimates an average temperature associated with the flow of air in step 809. It should be appreciated that the control arrangement may utilize information other than the temperature information to estimate an average temperature. By way of example, if a long wire resistance thermometer is formed from a strip of thin film on which more than one metal conductor is deposited, the control arrangement may use information such as a velocity associated with the air flow in estimating an average temperature along the interferometer beam path.

In step 813, any adjustments needed to account for the average temperature associated with the flow of air along the interferometer beam path are determined. Given the velocity of the air at any given time along an interferometer beam path, and the average temperature of the air, the temperature at that given time along the interferometer beam path may be estimated. The adjustments may be arranged to compensate for fluctuations in the wavelength of light associated with an interferometer beam. As will be appreciated by those skilled in the art, the wavelength of lasers associated with interferometers vary as the density of a transmitting medium, e.g., air, varies.

Once adjustments are determined, the adjustments are provided to a controller, e.g., control software, in step 817. Controller may then make the adjustments in order to substantially compensate for the fluctuations in the wavelength of light that may be due to temperature fluctuations. The process of accounting for temperature changes is then completed.

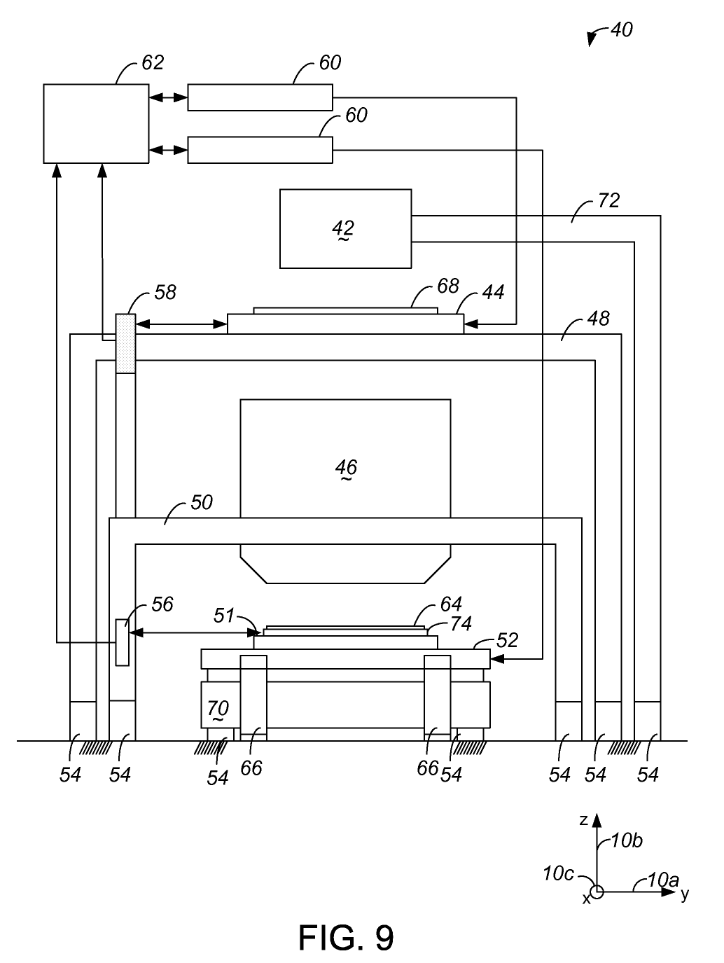

With reference to FIG. 9, a photolithography apparatus which may include the capability of substantially measuring the temperature of air flow over an interferometer beam will be described in accordance with an embodiment of the present invention. A photolithography apparatus (exposure apparatus) 40 includes a wafer positioning stage 52 that may be driven by a planar motor (not shown), as well as a wafer table 51 that is magnetically coupled to wafer positioning stage 52 by utilizing an EI-core actuator, e.g., an EI-core actuator with a top coil and a bottom coil which are substantially independently controlled. The planar motor which drives wafer positioning stage 52 generally uses an electromagnetic force generated by magnets and corresponding armature coils arranged in two dimensions.

A wafer 64 is held in place on a wafer holder or chuck 74 which is coupled to wafer table 51. Wafer positioning stage 52 is arranged to move in multiple degrees of freedom, e.g., in up to six degrees of freedom, under the control of a control unit 60 and a system controller 62. In one embodiment, wafer positioning stage 52 may include a plurality of actuators and have a configuration as described above. The movement of wafer positioning stage 52 allows wafer 64 to be positioned at a desired position and orientation relative to a projection optical system 46.

Wafer table 51 may be levitated in a z-direction 10b by any number of voice coil motors (not shown), e.g., three voice coil motors. In one described embodiment, at least three magnetic bearings (not shown) couple and move wafer table 51 along a y-axis 10a. The motor array of wafer positioning stage 52 is typically supported by a base 70. Base 70 is supported to a ground via isolators 54. Reaction forces generated by motion of wafer stage 52 may be mechanically released to a ground surface through a frame 66. One suitable frame 66 is described in JP Hei 8-166475 and U.S. Pat. No. 5,528,118, which are each herein incorporated by reference in their entireties.

An illumination system 42 is supported by a frame 72. Frame 72 is supported to the ground via isolators 54. Illumination system 42 includes an illumination source, which may provide a beam of light that may be reflected off of a reticle. In one embodiment, illumination system 42 may be arranged to project a radiant energy, e.g., light, through a mask pattern on a reticle 68 that is supported by and scanned using a reticle stage 44 which includes a coarse stage and a fine stage. The radiant energy is focused through projection optical system 46, which is supported on a projection optics frame 50 and may be supported the ground through isolators 54. Suitable isolators 54 include those described in JP Hei 8-330224 and U.S. Pat, No. 5,874,820, which are each incorporated herein by reference in their entireties.

A first interferometer 56 is supported on projection optics frame 50, and functions to detect the position of wafer table 51. Interferometer 56 outputs information on the position of wafer table 51 to system controller 62. In one embodiment, wafer table 51 has a force damper which reduces vibrations associated with wafer table 51 such that interferometer 56 may accurately detect the position of wafer table 51. A second interferometer 58 is supported on projection optical system 46, and detects the position of reticle stage 44 which supports a reticle 68. Interferometer 58 also outputs position information to system controller 62. The calibration of interferometer beams generated by interferometers 56, 58 to determine positions of table 51 and stage 44, respective, may be determined at least partly using information provided by long wire resistance thermometers (not shown).

It should be appreciated that there are a number of different types of photolithographic apparatuses or devices. For example, photolithography apparatus 40, or an exposure apparatus, may be used as a scanning type photolithography system which exposes the pattern from reticle 68 onto wafer 64 with reticle 68 and wafer 64 moving substantially synchronously. In a scanning type lithographic device, reticle 68 is moved perpendicularly with respect to an optical axis of a lens assembly (projection optical system 46) or illumination system 42 by reticle stage 44. Wafer 64 is moved perpendicularly to the optical axis of projection optical system 46 by a wafer stage 52. Scanning of reticle 68 and wafer 64 generally occurs while reticle 68 and wafer 64 are moving substantially synchronously.

Alternatively, photolithography apparatus or exposure apparatus 40 may be a step-and-repeat type photolithography system that exposes reticle 68 while reticle 68 and wafer 64 are stationary, i.e., at a substantially constant velocity of approximately zero meters per second. In one step and repeat process, wafer 64 is in a substantially constant position relative to reticle 68 and projection optical system 46 during the exposure of an individual field. Subsequently, between consecutive exposure steps, wafer 64 is consecutively moved by wafer positioning stage 52 perpendicularly to the optical axis of projection optical system 46 and reticle 68 for exposure. Following this process, the images on reticle 68 may be sequentially exposed onto the fields of wafer 64 so that the next field of semiconductor wafer 64 is brought into position relative to illumination system 42, reticle 68, and projection optical system 46.

It should be understood that the use of photolithography apparatus or exposure apparatus 40, as described above, is not limited to being used in a photolithography system for semiconductor manufacturing. For example, photolithography apparatus 40 may be used as a part of a liquid crystal display (LCD) photolithography system that exposes an LCD device pattern onto a rectangular glass plate or a photolithography system for manufacturing a thin film magnetic head.

The illumination source of illumination system 42 may be g-line (436 nanometers (nm)), i-line (365 nm), a KrF excimer laser (248 nm), an ArF excimer laser (193 nm), and an F2-type laser (157 nm). Alternatively, illumination system 42 may also use charged particle beams such as x-ray and electron beams. For instance, in the case where an electron beam is used, thermionic emission type lanthanum hexaboride (LaB6) or tantalum (Ta) may be used as an electron gun. Furthermore, in the case where an electron beam is used, the structure may be such that either a mask is used or a pattern may be directly formed on a substrate without the use of a mask.

With respect to projection optical system 46, when far ultra-violet rays such as an excimer laser are used, glass materials such as quartz and fluorite that transmit far ultra-violet rays is preferably used. When either an F2-type laser or an x-ray is used, projection optical system 46 may be either catadioptric or refractive (a reticle may be of a corresponding reflective type), and when an electron beam is used, electron optics may comprise electron lenses and deflectors. As will be appreciated by those skilled in the art, the optical path for the electron beams is generally in a vacuum.

In addition, with an exposure device that employs vacuum ultra-violet (VUV) radiation of a wavelength that is approximately 200 nm or lower, use of a catadioptric type optical system may be considered. Examples of a catadioptric type of optical system include, but are not limited to, those described in Japan Patent Application Disclosure No. 8-171054 published in the Official gazette for Laid-Open Patent Applications and its counterpart U.S. Pat. No. 5,668,672, as well as in Japan Patent Application Disclosure No. 10-20195 and its counterpart U.S. Pat. No. 5,835,275, which are all incorporated herein by reference in their entireties. In these examples, the reflecting optical device may be a catadioptric optical system incorporating a beam splitter and a concave mirror. Japan Patent Application Disclosure (Hei) No. 8-334695 published in the Official gazette for Laid-Open Patent Applications and its counterpart U.S. Pat. No. 5,689,377, as well as Japan Patent Application Disclosure No. 10-3039 and its counterpart U.S. Pat. No. 5,892,117, which are all incorporated herein by reference in their entireties. These examples describe a reflecting-refracting type of optical system that incorporates a concave mirror, but without a beam splitter, and may also be suitable for use with the present invention.

The present invention may be utilized, in one embodiment, in an immersion type exposure apparatus if suitable measures are taken to accommodate a fluid. For example, PCT patent application WO 99/49504, which is incorporated herein by reference in its entirety, describes an exposure apparatus in which a liquid is supplied to a space between a substrate (wafer) and a projection lens system during an exposure process. Aspects of PCT patent application WO 99/49504 may be used to accommodate fluid relative to the present invention.

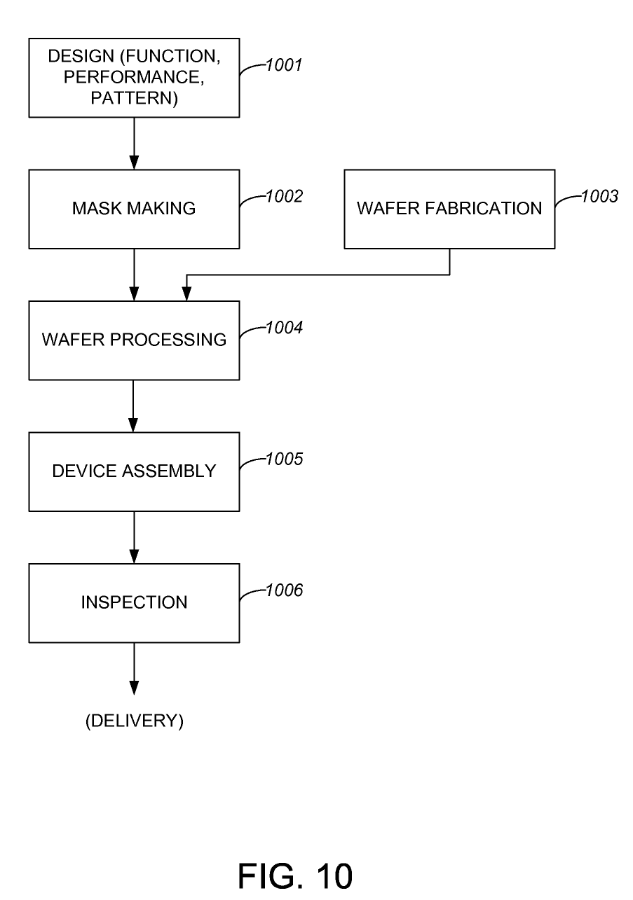

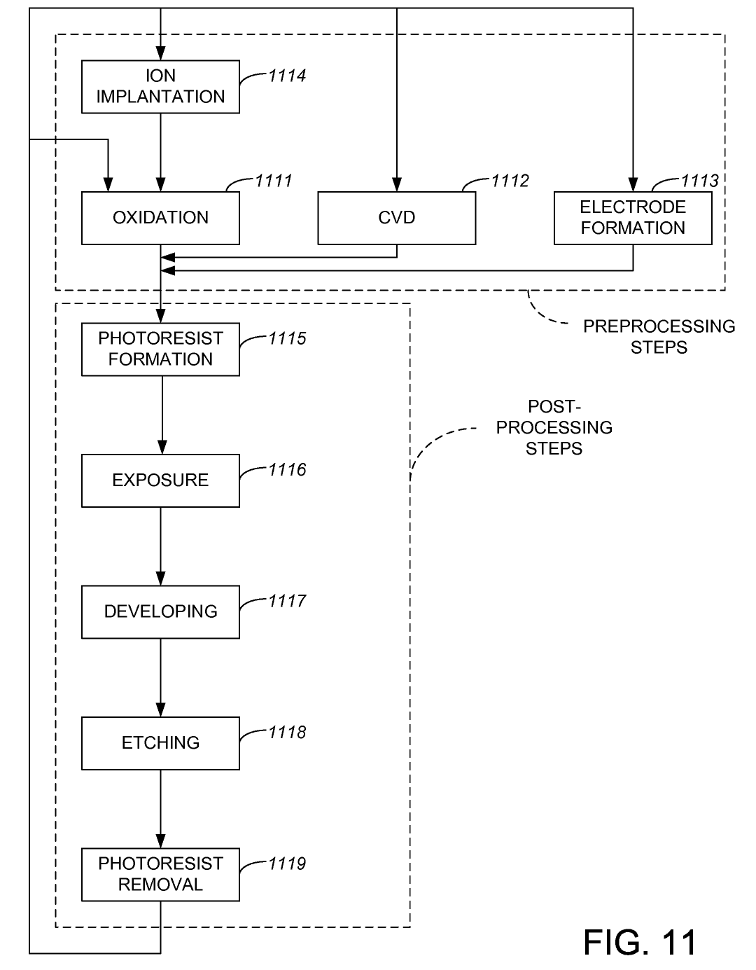

Further, semiconductor devices may be fabricated using systems described above, as will be discussed with reference to FIG. 10. FIG. 10 is a process flow diagram which illustrates the steps associated with fabricating a semiconductor device in accordance with an embodiment of the present invention. A process 1001 of fabricating a semiconductor device begins at step 603 in which the function and performance characteristics of a semiconductor device are designed or otherwise determined. Next, in step 1005, a reticle or mask in which has a pattern is designed based upon the design of the semiconductor device. It should be appreciated that in a substantially parallel step 1009, a wafer is typically made from a silicon material. In step 1013, the mask pattern designed in step 1005 is exposed onto the wafer fabricated in step 1009. One process of exposing a mask pattern onto a wafer will be described below with respect to FIG. 11. In step 1017, the semiconductor device is assembled. The assembly of the semiconductor device generally includes, but is not limited to including, wafer dicing processes, bonding processes, and packaging processes. Finally, the completed device is inspected in step 1021. Upon successful completion of the inspection in step 1021, the completed device may be considered to be ready for delivery.

FIG. 11 is a process flow diagram which illustrates the steps associated with wafer processing in the case of fabricating semiconductor devices in accordance with an embodiment of the present invention. In step 1101, the surface of a wafer is oxidized. Then, in step 1105 which is a chemical vapor deposition (CVD) step in one embodiment, an insulation film may be formed on the wafer surface. Once the insulation film is formed, then in step 1109, electrodes are formed on the wafer by vapor deposition. Then, ions may be implanted in the wafer using substantially any suitable method in step 1113. As will be appreciated by those skilled in the art, steps 1101-1113 are generally considered to be preprocessing steps for wafers during wafer processing. Further, it should be understood that selections made in each step, e.g., the concentration of various chemicals to use in forming an insulation film in step 1105, may be made based upon processing requirements.

At each stage of wafer processing, when preprocessing steps have been completed, post-processing steps may be implemented. During post-processing, initially, in step 1117, photoresist is applied to a wafer. Then, in step 1121, an exposure device may be used to transfer the circuit pattern of a reticle to a wafer. Transferring the circuit pattern of the reticle of the wafer generally includes scanning a reticle scanning stage which may, in one embodiment, include a force damper to dampen vibrations.

After the circuit pattern on a reticle is transferred to a wafer, the exposed wafer is developed in step 1125. Once the exposed wafer is developed, parts other than residual photoresist, e.g., the exposed material surface, may be removed by etching in step 1129. Finally, in step 1133, any unnecessary photoresist that remains after etching may be removed. As will be appreciated by those skilled in the art, multiple circuit patterns may be formed through the repetition of the preprocessing and post-processing steps.

Although only a few embodiments of the present invention have been described, it should be understood that the present invention may be embodied in many other specific forms without departing from the spirit or the scope of the present invention. By way of example, while the tubing used in a long wire resistance thermometer has been descried as insulating tubing such as polyimide tubing, substantially any suitable tubing may be used in a long wire resistance thermometer. In other words, the material used in the formation of a long wire resistance thermometer may vary. The tubing may be formed from a flexible material, in one embodiment. Additionally, while the use of a hollow tube in a long wire resistance thermometer has been described, a solid tube may be used in lieu of a hollow tube.

The dimensions of a long wire resistance thermometer may vary widely. For instance, as the distance over which an interferometer beam travels increases, the length of a long wire resistance thermometer increases. Typically, as the length of a long wire resistance thermometer increases, the diameter of the long wire resistance thermometer and/or the thickness of the walls of the long wire resistance thermometer may increase. It should be appreciated that the diameter of the long wire resistance thermometer may generally only increase by a relatively small amount without significantly affecting the performance of the long wire resistance thermometer.

A long wire resistance thermometer assembly which includes multiple metal conductors deposited on a strip of thin film may generally include any number of metal conductors. The number of metal conductors included in a long wire resistance thermometer assembly may be selected based on a number of factors including, but not limited to including, an amount of sensitivity desired for the long wire resistance thermometer assembly.

Polyimide has been described as being a suitable material from which an insulating tube and a strip of thin film may be formed. It should be appreciated that the types of polyimide from which tubes and thin films may be formed may vary widely. While Kapton has been described as being suitable for use in forming an insulating tube and a strip of thin film, other types of polyimide that may be used in forming an insulating tube and a strip of thin film may include, but are not limited to including, Apical and Kaptex. Further, materials other than polyimide may be used in the formation of insulating tubes and strips of thin film. Such other materials may include other polymers.

The operations associated with the various methods of the present invention may vary widely. By way of example, steps may be added, removed, altered, combined, and reordered without departing from the spirit or the scope of the present invention.

The many features and advantages of the present invention are apparent from the written description. Further, since numerous modifications and changes will readily occur to those skilled in the art, the invention should not be limited to the exact construction and operation as illustrated and described. Hence, all suitable modifications and equivalents may be resorted to as falling within the scope of the invention.

What is claimed is:

1. A resistance thermometer assembly comprising:
an insulating tube arrangement, the insulating tube arrangement including a first end and a second end, the insulating tube arrangement further including an insulating tube and a metal film layer, wherein the metal film layer coats the insulating tube;
a support arrangement, the support arrangement being configured to support the first end and the second end of the insulating tube arrangement; and
an electrical resistance arrangement, the electrical resistance arrangement being configured to measure a resistance associated with the insulating tube arrangement.

2. The resistance thermometer assembly of claim 1 wherein the electrical resistance arrangement is further configured to determine a temperature based on the resistance associated with the insulating tube arrangement.

3. The resistance thermometer assembly of claim 1 wherein the first end and the second end are plated with a metal.

4. The resistance thermometer assembly of claim 3 wherein the insulating tube is a polyimide tube, the metal film layer is one selected from the group including a layer of gold and a layer of platinum, and the first end and the second end are plated with gold.

5. The resistance thermometer assembly of claim 4 wherein the insulating tube includes an active region, the active region being located between the first end and the second end, the active region being sensitive to temperature changes, the first end and the second end being insensitive to temperature changes.

6. The resistance thermometer assembly of claim 4 wherein the support arrangement includes a first support and a second support, the first support having a first crimped end that supports the first end, the second support having a second crimped end that supports the second end.

7. The resistance thermometer assembly of claim 1 wherein the insulating tube has an outer diameter of approximately 0.34 millimeters (mm), and the metal film layer has a thickness of between approximately 0.034 micrometers (μm) and approximately 0.16 μm.

8. The resistance thermometer assembly of claim 6 wherein the insulating tube has a length of between approximately 10 centimeters (cm) and approximately 20 cm.

9. A stage apparatus comprising the resistance thermometer assembly of claim 1.

10. An exposure apparatus comprising the stage apparatus of claim 8.

11. A wafer formed using the apparatus of claim 10.

12. A resistance thermometer assembly comprising:
a flexible strip;
at least a first metal conductor, the at least first metal conductor being deposited on the flexible strip; and
a resistance arrangement, the resistance arrangement being configured to determine a resistance associated with the at least first metal conductor.

13. The resistance thermometer assembly of claim 12 wherein the flexible strip is formed from polyimide, and the metal conductor is formed from one selected from the group including gold and platinum.

14. The resistance thermometer assembly of claim 12 further including:
a second metal conductor, the second metal conductor being deposited on the flexible strip, wherein the second metal conductor is located at a distance from the first metal conductor and is approximately parallel to the first metal conductor.

15. The resistance thermometer assembly of claim 14 wherein the first metal conductor has a first length and the second metal conductor has a second length, the first length being approximately equal to the second length.

16. The resistance thermometer assembly of claim 14 wherein the first metal conductor has a first length and the second metal conductor has a second length, the first length being longer than the second length.

17. The resistance thermometer assembly of claim 14 wherein the resistance arrangement is further configured to determine a resistance associated with the second metal conductor and to use the resistance associated with the at least first metal conductor as well as the resistance associated with the second metal conductor to estimate a temperature.

18. The resistance thermometer assembly of claim 14 wherein the resistance arrangement is further configured to determine a resistance associated with the second metal conductor, the resistance thermometer assembly further including:
a multiplexing arrangement, the multiplexing arrangement being configured to select the resistance associated with the first metal conductor or the resistance associated with the second metal conductor, wherein the resistance arrangement is further configured to use a selected resistance to estimate a temperature.

19. The resistance thermometer assembly of claim 12 wherein the flexible strip is approximately 0.1 millimeters (mm) thick and approximately 25 mm wide, and wherein the at least first metal conductor is approximately 0.3 micrometers (μm) thick and approximately 0.5 mm wide.

20. A stage apparatus comprising the resistance thermometer assembly of claim 12.

21. An exposure apparatus comprising the stage apparatus of claim 20.

22. A wafer formed using the apparatus of claim 21.

23. A method of compensating for temperature effects in a stage system, the stage system including an interferometer and a stage, the interferometer being arranged to determine a position of the stage, the method comprising:
estimating a temperature of air, the air flowing over a beam provided by the interferometer, wherein estimating the temperature of the air includes determining a resistance associated with a resistance thermometer, the resistance thermometer including at least one polyimide structure and a metal structure, the resistance thermometer being positioned in the air such that the metal structure is parallel to a length of the beam;
processing the temperature of the air, wherein processing the temperature of the air includes determining whether the interferometer is to be adjusted to compensate for the temperature of the air; and
adjusting the interferometer when it is determined that the interferometer is to be adjusted to compensate for the temperature of the air.

24. The method of claim 23 wherein the polyimide structure is a polyimide tube and the metal structure is a metal coating formed on the polyimide tube.

25. The method of claim 24 wherein the metal coating is one selected from the group including gold and platinum.

26. The method of claim 23 wherein the polyimide structure is a polyimide film and the metal structure is a metal conductor deposited on the polyimide film.

27. The method of claim 26 wherein the metal conductor is one selected from the group including a gold conductor and a platinum conductor.

28. A stage apparatus comprising:
a stage;
an interferometer, the interferometer being arranged to measure a position of the stage using a beam;
a resistance thermometer assembly, the resistance thermometer assembly including at least one flexible structure and a metal structure, the resistance thermometer assembly being arranged such that the metal structure is parallel to a length of the beam, wherein the resistance thermometer assembly is arranged to estimate a temperature; and
a control arrangement, the control arrangement being configured to process the temperature and to adjust the beam to compensate for the temperature.

29. The stage apparatus of claim 28 further including:
a flow source, the flow source being arranged to provide an air flow over the beam, wherein the resistance thermometer assembly is positioned in the air flow and the temperature is a temperature of the air flow.

30. The stage apparatus of claim 28 wherein the polyimide structure is a polyimide tube and the metal structure is a metal coating formed on the polyimide tube.

31. The stage apparatus of claim 30 wherein the metal coating is one selected from the group including gold and platinum.

32. The stage apparatus of claim 28 wherein the polyimide structure is a polyimide film and the metal structure is a metal conductor deposited on the polyimide film.

33. The stage apparatus of claim 32 wherein the metal conductor is one selected from the group including a gold conductor and a platinum conductor.

34. An exposure apparatus comprising the stage apparatus of claim 28.

35. A wafer formed using the apparatus of claim 34.
